(19) United States
(12) Patent Application Publication
(10) Pub. No.: US 2005/0159024 A1
(43) Pub. Date: Jul. 21, 2005

(54) Relay arrangement structure

(75) Inventors: Hiroaki Yamada, Ogasa-gun (JP); Akemi Maebashi, Ogasa-gun (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/037,059

(22) Filed: Jan. 19, 2005

(30) Foreign Application Priority Data
Jan. 21, 2004 (JP) P2004-013364

(51) Int. Cl. H01R 12/00

(52) U.S. Cl. 439/64

(57) ABSTRACT

Two circuit boards 1′ and 3′ are disposed vertically, and the relays 2 and 4, provided respectively on the circuit boards, are arranged side by side in a vertical or a horizontal direction. Each of the circuit boards 1′ and 3′ include a bus bar circuit board, and terminals 7 of each relay 2, 4 are connected to bus bars 6, 13 of the corresponding bus bar circuit board. Part of the bus bars 6, 13 of each of the circuit boards 1′, 3′ project outwardly from the circuit board to provide terminal portions 6c, 13c for forming a connector. The bus bars 6 on the one circuit board 1′ and/or the bus bars 13 on the other circuit board 3′ are covered with respective insulating sub-boards 9 and 14 to be insulated respectively from the second relays 4 and the first relays 2.

### BACKGROUND OF THE INVENTION

This invention relates to a relay arrangement structure in which a plurality of relays are, for example, disposed vertically, and are arranged side by side within an electric connection box of an automobile or the like, thereby achieving a space-saving relay arrangement.

As a structure of arranging a plurality of relays, there has heretofore been extensively used the type of structure (not shown) in which the relays are arranged in a row on a plane within a relay box body made, for example, of a synthetic resin, and tab terminals of the relays are inserted respectively into wire-connected female terminals, received within the relay box body, to be connected thereto.

In this structure, however, the relays can not be arranged in any other way than on a plane, and therefore there have been encountered problems that a large arrangement space is required, that the relay box structure has an increased size due to the use of a plurality of wires, and that much time and labor are required for inserting the female terminals into the relay box body.

In an electric connection box shown in FIG. 4 bus bars 32 and a printed circuit are used instead of wires, thereby suppressing the increased size of the structure due to the use of wires (see Patent Literature 1)

This electric connection box 31 comprises a synthetic resin-made box body 33, the plurality of bus bars 32 made of electrically-conductive metal installed in a predetermined pattern on the surface of the box body 33, and a relay unit board 35 which is slid horizontally along guide portions 34 on the box body 33 to be mounted on this box body 33.

The relay unit board 35 includes a printed circuit board 36 having a printed circuit pattern formed on a reverse surface thereof, a plurality of relays 37 mounted in a row on an obverse surface of the printed circuit board 36, and various electronic parts 38 serving as relay control elements. After the relay unit board 35 is attached to the box body 33, the bus bars 32 are connected to the printed circuit pattern via relay terminals not shown. In FIG. 4, reference numeral 39 denotes a connector, and reference numeral 40 denotes a bus bar terminal.

In a relay box structure shown in FIGS. 5 and 6, a relay unit board 42 is disposed not horizontally but vertically within a box body 41, and bus bars 43 of the relay unit board 42 are connected to bus bars 44 of the box body 41 via relay terminals 45 (see Patent Literature 2).

A relay 46, the bus bars 43 and bus bars 47 are provided on the relay unit board 42, and terminal portions of the bus bars 43 are connected respectively to the bus bars 44 within the box body 41, and terminal portions of the bus bars 47 are received in a connector housing 48 of the box body 41 to form a connector for connection to an external wire harness. In FIG. 6, reference numeral 49 denotes a blade-type fuse.
Patent Literature 1: JP-A-58-182414 (Pages 2 to 5, FIG. 9)
Patent Literature 2: JP-A-59-28821 (Pages 4 and 5, FIGS. 4 and 5)

In the related relay arrangement structures shown in FIGS. 4 to 6, however, a plurality of relays 37, 46 can not be arranged in a space-saving manner, and when such a plurality of relays are mounted, there has been encountered a problem that the relay box, the electric connection box, an ECU box, a relay module, etc., for mounting on a vehicle increases in size.

### SUMMARY OF THE INVENTION

In view of the foregoing, it is an object of this invention to provide a relay arrangement structure in which a plurality of relays can be arranged in a space-saving manner within a relay box, a relay module or the like.

In order to accomplish the above object, a relay arrangement structure of the present invention is characterized by having the following arrangement:
(1) A relay arrangement structure comprising:
   a first circuit board;
   a first relay that is mounted on the first circuit board in a relay mounting direction;
   a second circuit board that is opposed to the first circuit board; and
   a second relay that is mounted on the second circuit board and arranged so that the first relay is displaced from the second relay in a direction perpendicular to the relay mounting direction to make a distance between the first and second circuit boards shorter than a sum of a height of the first and second relays.
(2) A relay arrangement structure according to (1), wherein the first and second circuit boards include bus bar circuit boards having bus bars, respectively, and the first and second relays include terminals connected to the bus bars of the corresponding bus bar circuit boards, respectively.
(3) A relay arrangement structure according to (2), wherein the bus bars include connectors that project from the first and second circuit boards, respectively.
(4) A relay arrangement structure according to (2), wherein the bus bar, which is opposed to at least one of the first and second relays, is covered with an insulating sub-board.
(5) A relay arrangement structure according to (1), wherein the first circuit board includes a plurality of the first relays, and the second circuit board includes a plurality of the second relays.
(6) A relay arrangement structure comprising:
   a first circuit board;
   a first relay that is mounted on the first circuit board in a relay mounting direction;
   a second circuit board that is opposed to the first circuit board; and
   a second relay that is mounted on the second circuit board, wherein a portion of the first relay is superposed on a portion of the second relay in a direction perpendicular to the relay mounting direction.

According to the invention, the plurality of relays are arranged in adjacent relation between the two circuit boards, and therefore the relays can be arranged at a high density, so that the space-saving arrangement of the relays can be achieved. As a result, for example, a relay box, an electric connection box or the like for mounting on an automobile can be formed into a compact design, and therefore a mounting space is reduced, and such a box can be mounted in a narrow space.

According to the invention, the relays are arranged in adjacent relation along the perpendicular circuit boards, and an upper dead space within a relay box, an electric connection box or the like can be effectively used as the relay-mounting space, and the relay box, the electric connection box or the like can be formed into a more compact design.

According to the invention, the Wires do not need to be used because of the provision of the bus bars, and therefore the structure of each circuit board is simplified, and is space-saving, and the relay box, the electric connection box or the like can be formed into a more compact design.

According to the invention, because of the connectors that project from the circuit boards, the supply of electric power to the relays and the supply of electricity from the relays can be effected easily in a space-saving manner.

According to the invention, for example, a malfunction or the like of the second relay during energization of the bus bars of the one circuit board can be positively prevented, so that the reliability of operation of the relay is enhanced.

### BRIEF DESCRIPTION OF THE DRAWINGS

FIG. 1 is an exploded, perspective view showing one preferred embodiment of a relay arrangement structure of the present invention.

FIG. 2 is a perspective view showing the relay arrangement structure in its assembled condition.

FIGS. 3A to 3C are side-elevational views of modified relay arrangement structures of the invention.

FIG. 4 is an exploded, perspective view of an electric connection box including a related relay arrangement structure.

FIG. 5 is a perspective view showing another related relay arrangement structure.

FIG. 6 is a vertical cross-sectional view of a relay box including the related relay arrangement structure of FIG. 5.

FIG. 7 is an overhead view showing the relay arrangement structure of the invention.

FIG. 8 is a side-elevational view of a relay arrangement structure of the invention, which includes relays having different shapes.

### DETAIL DESCRIPTION OF PREFERRED EMBODIMENTS

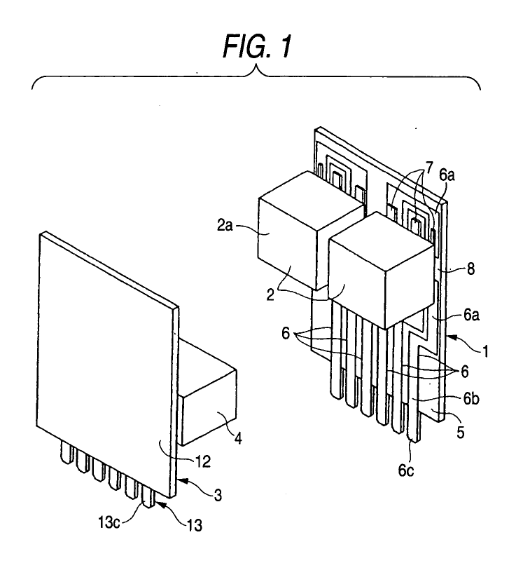

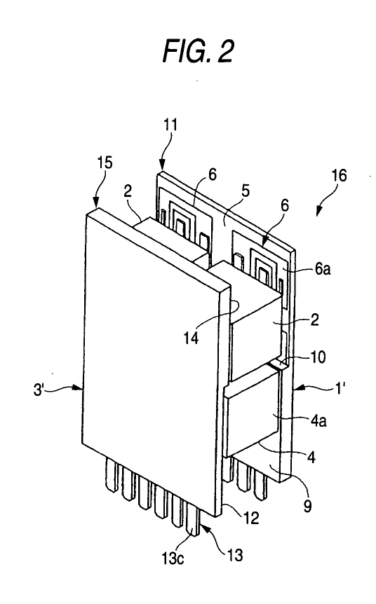

FIGS. 1 and 2 show one preferred embodiment of a relay arrangement structure of the present invention.

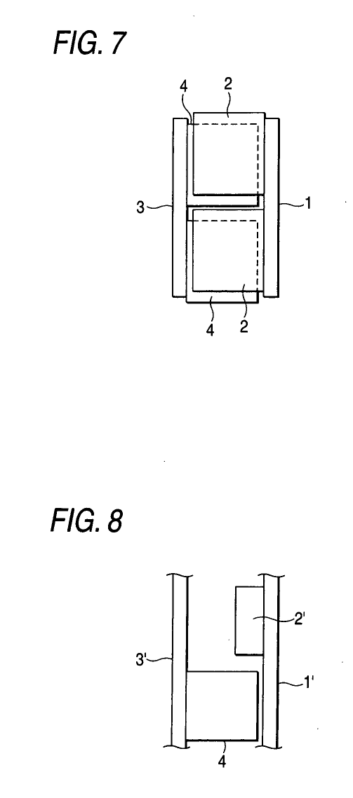

In this relay arrangement structure, a pair of relays 2 are mounted side by side on an upper half portion of a vertical bus bar circuit board (one circuit board) 1, while a pair of relays 4 are mounted side by side on a lower half portion of a vertical bus bar circuit board (the other circuit board) 3, as shown in FIG. 1. As shown in FIG. 2, the two bus bar circuit boards 1 and 3 are opposed to each other in a relay mounting direction, so that the relays 2 on the one bus bar circuit board 1 and the relays 4 on the other bus bar circuit board 3 are arranged side by side in a vertical direction perpendicular to the relay mounting direction. In other words, the relays 2, 4 are so arranged that the relays 2 is displaced from the relays 4 in the vertical direction to make a distance between the two bus bar circuit boards 1 and 3 shorter than a sum of heights of the relays 2 and the relays 4. FIG. 7 shows the relay arrangement structure viewing from above. As shown in FIG. 7, the relays 2, 4 are arranged so that portions of the relays 2 are superposed on portions of the relays 4 in the vertical direction. When at least a part of the relays 2 is superposed on the relays 4, the distance can be set shorter than a sum of their heights. Therefore, a plurality of relays can be arranged in a space-saving.

In FIG. 1, the one bus bar circuit board 1 includes a rectangular insulating board 5 made of a synthetic resin, and a plurality of relatively-long bus bars 6 made of electrically-conductive metal installed on an inner surface of the insulating board 5. Tab-like terminals 7 of the relays 2 are connected to the bus bars 6 preferably by welding, soldering or the like. The bus bars 6 are firmly fixed to the insulating board 5, for example, by insert molding or the like, in such a manner that the surfaces of the bus bars 6 are exposed.

The plurality of terminals 7, the number of which is determined in accordance with the number of contacts (not shown) provided within the relay of the first relay 2, project vertically from a bottom portion of the relay 2. In this embodiment, the terminals 7, leading to the contacts and a coil within one relay 2, are connected by three bus bars 6 (which are interrupted at their intermediate portions as at 8).

Each of the bus bars 6 include an upper-side relay connection portion 6a, an extension portion 6b extending downwardly from the relay connection portion 6a, and a tab-like terminal portion 6c which extends straight downwardly from the extension portion 6b, and projects outwardly beyond a lower end of the insulating board 5. The extension portions 6b are arranged side by side at equal intervals.

The relay connection portions 6a are formed into a suitable pattern in accordance with the number and positions of the terminals 7 of the relay 2. The terminal portions 6c are arranged side by side at equal intervals, and project into a connector fitting chamber of a connector housing of a box made for example of a synthetic resin not shown, such as a relay box body, an ECU box body or an electric connection box, to form a connector for connection to an external wire harness.

As shown in FIG. 2, an insulating sub-board 9 is formed by adhesive bonding, integral resin-molding or the like on that side of the lower half portion of the bus bar circuit board 1 at which the surfaces of the extension portions 6b of the bus bars 6 are disposed, and therefore the extension portions 6b of the bus bars 6 are insulated from the exterior, thereby preventing adverse electrical effects (such as a malfunction of the contacts) on the relays 4 disposed in proximity to the extension portions 6b. In the case where the insulating sub-board 9 is formed by integral resin-molding, a bus bar circuit board 1′ of an integrally-molded construction, shown in FIG. 2, is used instead of the bus bar circuit board 1 of FIG. 1.

Head portions 4a of the relays 4 are disposed in proximity to or in contact with the surface of the insulating sub-board 9. A stepped portion 10 is formed at the boundary between the insulating sub-board 9 and the upper half portion of the insulating board 5 where the relay connection portions 6a are provided. The bus bar circuit board 1′, including the insulating sub-board 9, and the relays 2 jointly form a first relay connection unit 11.

In FIG. 1, the other bus bar circuit board 3 comprises a rectangular insulating board 12 that is made of a synthetic resin, and has the same shape as the insulating board 5, and a plurality of relatively-short bus bars 13 made of electrically-conductive metal installed on an inner surface of the insulating board 12. Tab-like terminals (not shown) of the relays 4 are connected to the bus bars 13 preferably by welding, soldering or the like as described above for the terminals 7. The bus bars 13 are firmly fixed to the insulating board 12, for example, by insert molding, in such a manner that the surfaces of the bus bars 13 are exposed.

The plurality of terminals, the number of which is determined in accordance with the number of contacts (not shown) provided within the relay of the relay 4, project vertically from a bottom portion of the relay 4 as described above for the relay 2. In this embodiment, the terminals, leading to the contacts and a coil within one relay 4, are connected by three bus bars 13 (which are interrupted at their intermediate portions).

Each of the bus bars 13 include an upper-side (which means an upper portion of a lower half portion of the insulating board 12) relay connection portion (similar to the relay connection portion 6a), a short extension portion extending downwardly from the relay connection portion, and a tab-like terminal portion 13c which extends straight downwardly from the extension portion and projects outwardly beyond a lower end of the insulating board 12. The extension portions are arranged side by side at equal intervals. In the case where each relay 4 is provided near to the lower end of the insulating board 12, the provision of the extension portions of the bus bars 13 may be omitted, in which case the relay connection portions are extended to be connected directly to the terminal portions 13c. The arrangement of the relay connection portions and the arrangement of the terminal portions 13c are similar to those in the bus bar circuit board 1.

The terminal portions 13c are arranged side by side at equal intervals, and project into a connector fitting chamber of a connector housing of a box made for example of a synthetic resin, such as a relay box body, an ECU box body or an electric connection box, to form a connector for connection to an external wire harness. There can be used a large-size connector housing common to the terminal portions 13c and the terminal portions 6c of the bus bar circuit board 1, in which case a total of twelve terminal portions 6c and 13c that is, six terminal portions 6c and six terminal portions 13c are arranged in two front and rear rows in the connector housing.

As shown in FIG. 2, an insulating sub-board 14 is formed by adhesive bonding, integral resin-molding or the like on the upper half portion of the bus bar circuit board 3 to provide a thickened portion which is to be opposed to head portions 2a of the relays 2 (FIG. 1). The head portions 2a of the relays 2 are disposed in proximity to or in contact with the surface of the insulating sub-board 14. Even if this insulating sub-board 14 is not provided, this will not offer any problem. However, the insulating sub-board 14 is useful for increasing the strength of the insulating board 12 and also for increasing the creepage distance between the relays 2 and the bus bars 13. A bus bar circuit board 3′, including the insulating sub-board 14, and the relays 4 jointly form a relay connection unit 15.

The bus bar circuit boards 1′ and 3′ of the two relay connection units 11 and 15 are disposed vertically opposed relation to each other as shown in FIG. 2. With this arrangement, the relays 2, located at the upper side, are disposed in closely opposed relation to the relays 4 located at the lower side, and therefore the relays 2 and 4 can be arranged at a high density in a small space in the vertical direction.

A relay module 16 is formed by the two relay connection units 11 and 15, and this relay module 16 is received within the box body such for example as a relay box body, an electric connection box body or an ECU box body, and the terminal portions 6c and 13c of the bus bars 6 and 13 project into the connector housing to be disposed therein, and the wire harness is connected via to this connector, and electric power is sup plied to the coils provided within the relays 2 and 4, and also electrical signals are transmitted to auxiliary equipments or others of an automobile electrically connected to the contacts of the relays 2 and 4.

In the embodiment of FIGS. 1 and 2, although the two relays 2 are provided on the one bus bar circuit board 1′ while the two relays 4 are provided on the other bus bar circuit board 3′, the number of the relays 2, as well as the number of the relays 4, is not limited to two, and is also not limited to the arrangement in which the two relays are arranged side by side in the right-left direction. One relay 2, 4 can be provided on each bus bar circuit board 1′, 3′, or three or more relays 2, 4 can be provided on each bus bar circuit board in adjacent relation to one another in the right-left direction.

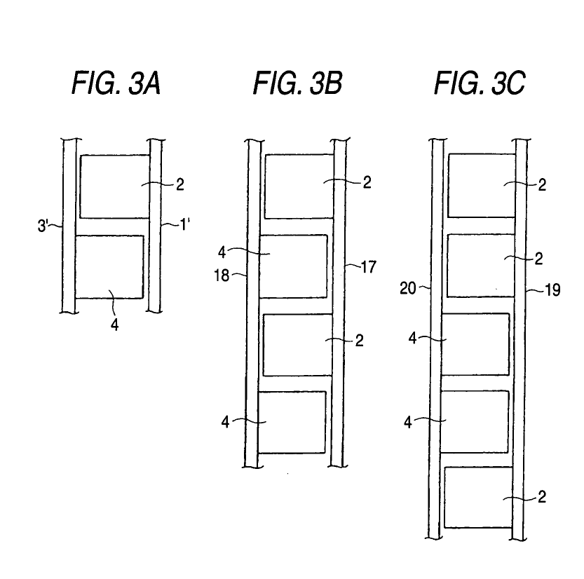

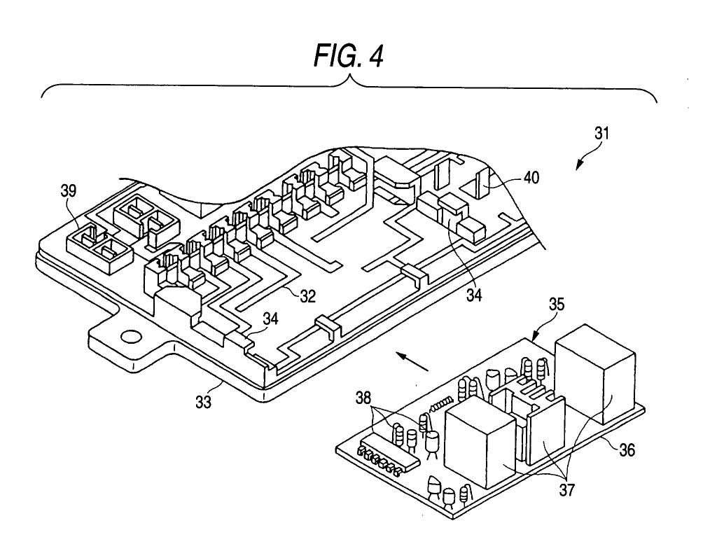

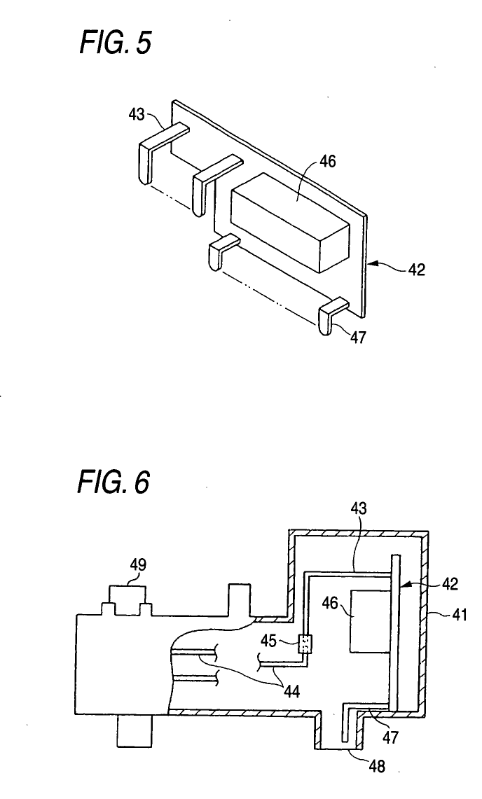

FIGS. 3A to 3C show examples of arrangements in which relays are arranged in an upward-downward (vertical) direction, and FIG. 3A shows the arrangement of FIG. 2 and also shows a modified example of the arrangement of FIG. 2 in which instead of providing two relays 2, 4 on each bus bar circuit board 1′, 3′, only one relay 2, 4 is provided on each bus bar circuit board 1′, 3′. In FIGS. 3A to 3C, the showing of bus bars and terminals of the relays are omitted.

In FIG. 3B, relays 2 are provided on one bus bar circuit board 17, while relays 4 are provided on the other circuit board 18 such that the relays 2 and 4 in one or each column are disposed alternately in the upward-downward direction. In FIG. 3C, a plurality of (for example, two) relays 2 are provided on one bus bar circuit board 19 in adjacent relation to each other in the upward-downward direction in one or each column, while a plurality of (for example, two) relays 4 are provided on the other circuit board 20 in adjacent relation to each other in the upward-downward direction in one or each column such that the relays 4 are disposed adjacent to the lower side of the two relays 2, and further relays 2 are disposed adjacent to the lower side of the two relays 4.

In the examples of FIGS. 3B and 3C, bus bars can be installed vertically on and along each insulating board (designated by reference numeral 17, 18, 19, 20 for convenience) such that the bus bars are common to (that is, are connected to) the vertically-arranged relays 2, 4. Alternatively, bus bars can be installed horizontally on each insulating board in such a manner that the corresponding bus bars are connected to each relay 2, 4 separately from the other bus bars.

Any other suitable arrangement than the arrangements of FIGS. 3A to 3C can be adopted in so far as the relays 2 and 4 are disposed side by side in the upward-downward direction. Furthermore, instead of arranging the relays 2 and 4 in the upward-downward (vertical) direction between the two vertical bus bar circuit boards, the relays can be arranged side by side in the right-left (horizontal) direction between the two bus bar circuit boards. In this case, also, the relays are arranged as shown in FIGS. 3A to 3C or in any other suitable form.

The present invention can also be applied to an arrangement in which relays have different shapes as shown in FIG. 8. A height of relays 2′ is shorter than that of relays 2. In the same manner with the above embodiments, the relays 2′ is displaced from the relays 4 in a direction perpendicular to the relay mounting direction so that a distance between the two bus bar circuit boards can be set shorter than a sum of a height of the relays 2′ and the relays 4.

Instead of using the bus bar circuit boards 1′ and 3′, printed circuit boards can be used, in which case tab terminals, replacing the bus bar terminals 6c and 13c, are connected by soldering or the like to printed circuit patterns on the surface of the printed circuit board. In the case where instead of the bus bars or the printed circuit boards, wires are used to form the required circuits, wire holding grooves, wire holding projections or the like are preferably provided at each insulating board serving as a printed board so as to hold the wires against hanging down.

1. A relay arrangement structure comprising:
a first circuit board;
a first relay that is mounted on the first circuit board in a relay mounting direction;
a second circuit board that is opposed to the first circuit board; and
a second relay that is mounted on the second circuit board and arranged so that the first relay is displaced from the second relay in a direction perpendicular to the relay mounting direction to make a distance between the first and second circuit boards shorter than a sum of a height of the first and second relays.

2. A relay arrangement structure according to claim 1, wherein the first and second circuit boards include bus bar circuit boards having bus bars, respectively, and the first and second relays include terminals connected to the bus bars of the corresponding bus bar circuit boards, respectively.

3. A relay arrangement structure according to claim 2, wherein the bus bars include connectors that project from the first and second circuit boards, respectively.

4. A relay arrangement structure according to claim 2, wherein the bus bar, which is opposed to at least one of the first and second relays, is covered with an insulating sub-board.

5. A relay arrangement structure according to claim 1, wherein the first circuit board includes a plurality of the first relays, and the second circuit board includes a plurality of the second relays.

6. A relay arrangement structure comprising:
a first circuit board;
a first relay that is mounted on the first circuit board in a relay mounting direction;
a second circuit board that is opposed to the first circuit board; and
a second relay that is mounted on the second circuit board, wherein a portion of the first relay is superposed on a portion of the second relay in a direction perpendicular to the relay mounting direction.
